(19) United States
(12) Patent Application Publication
(10) Pub. No.: US 2010/0167689 A1
(43) Pub. Date: Jul. 1, 2010

(54) METHOD AND APPARATUS FOR DETERMINING WHETHER A CELLULAR PHONE CHIP IS DORMANT

(76) Inventors: Hossein Alexander Sepehri-Nik, Coral Gables, FL (US); Marcelo Caneppele, Campinas-SP (BR)

Correspondence Address: GIBSON & DERNIER LLP, 900 ROUTE 9 NORTH, SUITE 504, WOODBRIDGE, NJ, 07095, US

(21) Appl. No.: 12/498,201

(22) Filed: Jul. 6, 2009

Related U.S. Application Data
(60) Provisional application No. 61/078,594, filed on Jul. 7, 2008.

(51) Int. Cl. H04M 11/00

(52) U.S. Cl. 455/405

(57) ABSTRACT

Methods and systems are provided for determining whether a cellular telephone chip is dormant. Determinations are drawn from testing telephone numbers associated with chips and data collected is used to generate statistics. Methods are provided for determining the percentage of a wireless service provider's subscriber-base that consists of abandoned, or non-revenue-generating, customers.

### CROSS-REFERENCE TO RELATED APPLICATION

The present application claims priority benefit under 35 U.S.C. §119(e) of U.S. Provisional Application Ser. No. 61/078,594 filed Jul. 7, 2008, the entirety of which is incorporated herein by reference.

### FIELD OF INVENTION

The present invention relates to methods and apparatus for measuring metrics in the cellular phone market. More particularly, the present invention relates to a method and apparatus for determining the percentage of a wireless service provider's subscriber-base that consists of abandoned, or non-revenue-generating, customers.

### BACKGROUND OF THE INVENTION

Wireless communications have become prevalent all over the world. However, the wireless markets in the many countries of the world have many different looks to them. In the United States approximately 95% of wireless communications users are what is referred to as post-paid “subscribers”. This generally means that the subscriber enters into a contract for service (with a wireless service provider) for a term of service. The post-paid subscriber then uses a wireless communications device on the wireless service provider's network. Then, at some later point, the subscriber receives a bill from the service provider for the service(s) that he/she has used up to a certain date.

The remaining 5% of wireless users in the United States are pre-paid “customers”. This means that the customer is assigned a number from a wireless service provider and then pays a certain amount for network usage in advance of incurring any charges. Once the amount previously paid to the wireless service provider is used up, it is up to the customer to deposit more money into their wireless account so that they may continue to use their wireless device.

As the percentages above show, the pre-paid market in the US is minute compared to the post-paid market. This is not reflective of the wireless market everywhere. For instance, in most of South America approximately ninety percent (90%) of wireless communications users are pre-paid customers versus approximately ten percent (10%) post-paid subscribers.

In most countries that have a predominantly pre-paid customer base, the profit margins on these pre-paid services are extremely small relative to the margins on the post-paid services. This is partially driven by the fact that the customers needing to purchase pre-paid services are often doing so because they have limited disposable income for such services and perhaps little, or no credit. As such, they need to purchase smaller packages without many extras—as their finances allow. These pre-paid packages allow them access to these forms of wireless communications.

In contrast, the post-paid subscriber market in these countries (although smaller in percentage), make up a much more profitable market for the wireless service providers. These post-paid subscribers tend to be wealthier individuals, business accounts, or other types of subscribers that simply have more credit and/or money to pay for these services. For the most part, these post-paid subscribers have already subscribed to a wireless service provider—and competition for their (more lucrative) business is fierce amongst the carriers.

Wireless service providers need to obtain reliable market statistics about their customer-base, as well as those of their competition, in order to make strategic and tactical decisions. Since wireless service providers are competing over the same subscribers, these wireless service providers are not inclined to share customer/subscriber-base information with their competitors. Accordingly, it is necessary for these wireless service providers to obtain reliable measurements of market share information, preferably broken down by pre-paid versus post-paid market segments.

“Gross” market share information is sometimes available to wireless service providers. This means that information is sometimes available to the service providers regarding what percentage, or share, of the total (pre-paid plus post-paid) wireless market they maintain.

This “gross” market share information can be gathered in a number of ways. For instance, in Brazil, gross market share information is publicly reported on a monthly basis by ANATEL—the country's equivalent of the FCC in the USA.

Wireless service providers wish to know what percentage of market share that they have had historically and/or currently maintain, and whether they are losing subscribers over time—and if so, who are they losing them to and why.

One area of concern for service providers is the reliability of collected data. One problem in data reliability stems from cellular phone chips that are abandoned, or “dormant”. The SIM card or chip is the brain of the phone and is one way to allow a user to make calls. The card may be prepaid so that so that a user need not receive a phone bill and can maintain control of expenditures. When necessary, the user can simply add talk time to the card by, for example, purchasing recharge cards and entering the PIN number on the handset. In some instances, incoming calls may be free in certain cities; therefore even if the card is depleted a user may still be able to receive incoming calls.

Due to contractual obligations, post-paid subscribers always generate a certain level of minimum monthly revenue for their carrier. In contrast, the pre-paid customer has little interaction with his/her carrier after they initially purchase their cellular chip. They will purchase minutes before using them through local stores and newsstands. A problem exists today in many countries where pre-paid customers may purchase a cellular chip from a wireless service provider, are assigned a telephone number by the carrier, and yet for various reasons the user does not use that cellular chip to place telephone calls, or generate any revenue for the carrier, yet they are still reflected as a “customer” for subscriber-base measurement and reporting. It is extremely common for these pre-paid customers to switch carriers simply by purchasing a cellular chip from a competitor, replacing it for the old chip (in their existing phone), and never going through the seemingly unnecessary step of notifying their old carrier that they have absolutely no intention of using their service ever again.

The old carrier continues to include this former customer in the subscriber count. This creates artificial market share for the former carrier, who may have absolutely no reason to go through the internal effort to identify these former customers and remove them from their subscriber count (internal or external). There are no regulations known to require this step.

It is valuable information for a competitive carrier to know what percentage of his (and perhaps, more importantly, his competition's) subscriber base is actually made up of these abandoned or “dormant” chips.

Accordingly, it would be desirable to provide methods and apparatus to determine whether a cellular phone chip is dormant, and if so, to measure “dormant” vs. revenue generating cellular chips.

### SUMMARY OF THE INVENTION

The present invention provides methods and apparatus for determining whether a cellular phone chip is dormant and what percentage of a wireless service provider's market share is represented by these types of chips.

In one embodiment a method of measuring market share is provided through monitoring responsive SS7 signaling and using statistical modeling to report dormant vs. revenue generating cellular chips.

In accordance with another embodiment of the present invention, a method is provided wherein a message is sent to a telephone number and the response is interpreted to determine whether the chip at the assigned number is dormant. In a preferred embodiment the method employs an automated SS7 signal interpretation algorithm.

In one embodiment a method is provided to estimate the quantity of telephone numbers belonging to mobile service provider(s) that have been assigned to a customer, but that have since been abandoned by the customers, yet that are still (incorrectly) being considered part of the service provider(s)' active customer-base and market share, (so called “dormant” chips).

In accordance with one embodiment, a method of estimating the quantity of dormant chips may include identifying, within a selected sample of numbers, those chips that are no longer being used by the customer, and applying a statistical model to estimate the total quantity of numbers that have been “abandoned” by their users within the service provider(s)' current customer-base.

In a further embodiment a system is provided that is operable to determine whether a mobile telephone chip is dormant, the system comprising a call generator, a signaling monitor and server wherein the call generator is connected to a telephone exchange.

### BRIEF DESCRIPTION OF THE DRAWINGS

Other objects and advantages of the invention will become apparent to those skilled in the art upon reading the following detailed description of preferred embodiments, in conjunction with the accompanying drawings, wherein like reference numerals have been used to designate like elements, and wherein:

FIG. 1 is a diagrammatic representation of a general environment within which one or more embodiments of the present invention are employed;

FIG. 2 is a block diagram depicting a method in accordance with at least one embodiment of the present invention;

FIG. 2A is a block diagram depicting a method in accordance with at least one embodiment of the present invention;

FIG. 2B is a block diagram depicting a method in accordance with at least one embodiment of the present invention;

FIG. 2C is a block diagram depicting a method in accordance with at least one embodiment of the present invention;

FIG. 2D is a block diagram depicting a method in accordance with at least one embodiment of the present invention;

FIG. 2E is a block diagram depicting a method in accordance with at least one embodiment of the present invention;

FIG. 2F is a block diagram depicting a method in accordance with at least one embodiment of the present invention;

FIG. 3 is a block diagram depicting a method of testing carrier-market samples in accordance with at least one embodiment of the present invention;

FIG. 4 is a block diagram depicting a method of testing an individual number from a carrier-market sample in accordance with at least one embodiment of the present invention;

FIG. 5 is a block diagram depicting a method of determining whether a number is assigned or unassigned in accordance with at least one embodiment of the present invention;

FIG. 6 is a block diagram depicting a method of classifying a number in accordance with at least one embodiment of the present invention;

FIG. 7 is a diagrammatic representation of a method in accordance with at least one embodiment of the present invention;

FIG. 8 is a diagrammatic representation of a logical architecture of a system in accordance with at least one embodiment of the present invention;

FIG. 9 is a diagrammatic representation of a system in accordance with at least one embodiment of the present invention; and

FIG. 10 is a diagrammatic representation of logic for a system in accordance with at least one embodiment of the present invention.

### DETAILED DESCRIPTION OF THE PREFERRED EMBODIMENTS

In the following description, for the purposes of explanation, specific numbers, materials and configurations are set forth in order to provide a thorough understanding of the invention. It will be apparent, however, to a person of ordinary skill in the art, that these specific details are merely exemplary embodiments of the invention. In some instances, well known features may be omitted or simplified so as not to obscure the present invention. Furthermore, reference in the specification to “one embodiment” or “an embodiment” is not meant to limit the scope of the invention, but instead merely provides an example of a particular feature, structure or characteristic of the invention described in connection with the embodiment. Insofar as various embodiments are described herein, the appearances of the phase “in an embodiment” in various places in the specification are not meant to refer to a single or same embodiment. As will be apparent to those skilled in the art, as used herein, a “dormant chip” may be associated with an “abandoned number”, i.e., a telephone number that is assigned to a subscriber SIM card/chip, but is no longer in use. However, if the abandoned number is generating revenue for the carrier, it is typically not technically considered a “dormant chip” for present purposes.

In one aspect a method for identification of a chip as “dormant” includes conducting a test of a specific number or set of numbers at a given frequency, such as but not limited to daily, for a given period of time, such as one week, and analyzing the results of the test. If there is no response from the subscriber of the number associated with the chip during the period of testing, or different signaling is obtained in this time period, the chip is classified as dormant. The period can be any time period. A preferred period is one to two weeks.

The method of determining whether a chip is “dormant” may include more than one phase of testing. For example, a first stage of testing may be employed to identify telephone numbers as “potentially dormant chips”. This first stage may include the steps mentioned above, wherein the set of numbers to be called may for example be the entire range of numbers for a given carrier. Once these “potentially dormant chips” are identified, a routine of more frequent tests may be conducted to check over a certain period of time if the state ever changes. For example, testing of the set of numbers marked as potentially dormant chips may include increasing the amount and frequency of testing of numbers over a period of time, so that tests are conducted at different times, and/or on different days of the week. If the state of potentially dormant chips does not change during the specified period of time, the number is finally classified as “dormant chip”.

In accordance with one embodiment, a system is programmed to recognize potentially dormant chips through responsive SS7 signaling. The numbers that are recognized and selected as potentially dormant are pinged and re-pinged for a series of days. Testing may be conducted in accordance with methods described in U.S. patent application Ser. No. 12/022,763 entitled Method And Apparatus For Measuring Distinctions Between Pre-Paid vs. Post-Paid Customer Base And Market Share For Wireless Communication Service Providers, the entirety of which is incorporated in full by reference herein.

The results of the testing may be used to generate a statistical model. The model may be trended up or extrapolated to show percent of subscriber base, and general market-share.

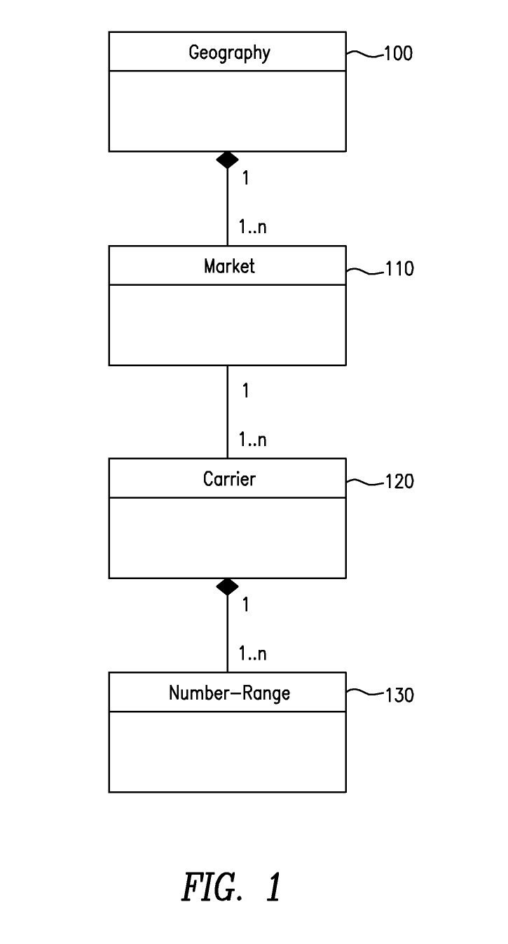

Now referring to the drawings, wherein like numerals indicate like elements, there is shown in FIG. 1 in accordance with at least one embodiment, a simplified block diagram depicting a framework within which the present inventions are employed. A geographic region 100 is segmented into one or more wireless markets 110. Each market 110 is in turn served by one or more wireless service providers (or “carriers”) 120. The combination of a carrier 120 and a market 100 is referred to as a “carrier-market”. Each carrier 120 is allocated ranges of numbers in blocks, identified as carrier number ranges 130. When Local Number Portability (LNP) is not in effect, a number is associated with the market 110 corresponding to the carrier number range 130 of which it is a part. When LNP is in effect, the market 100 may be determined by querying the Local Number Portability (LNP) database.

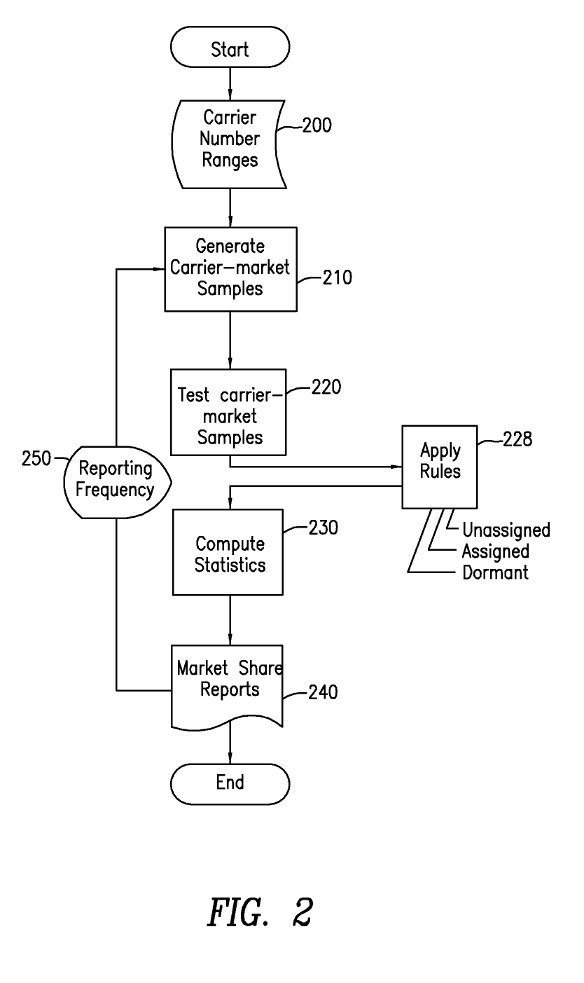

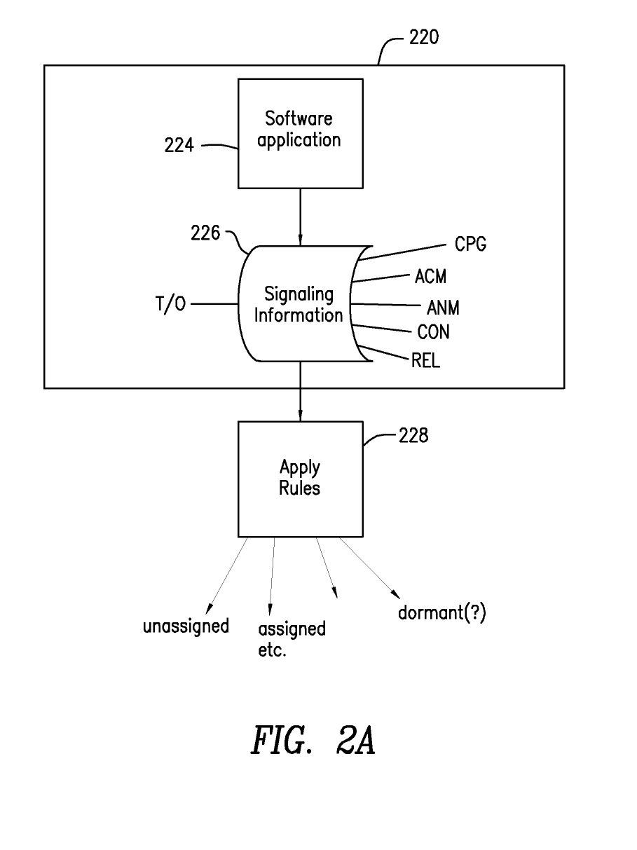

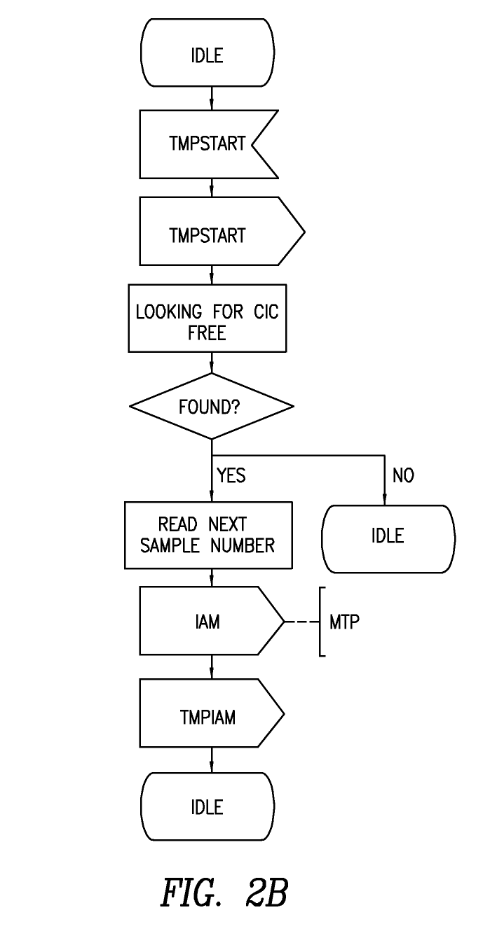

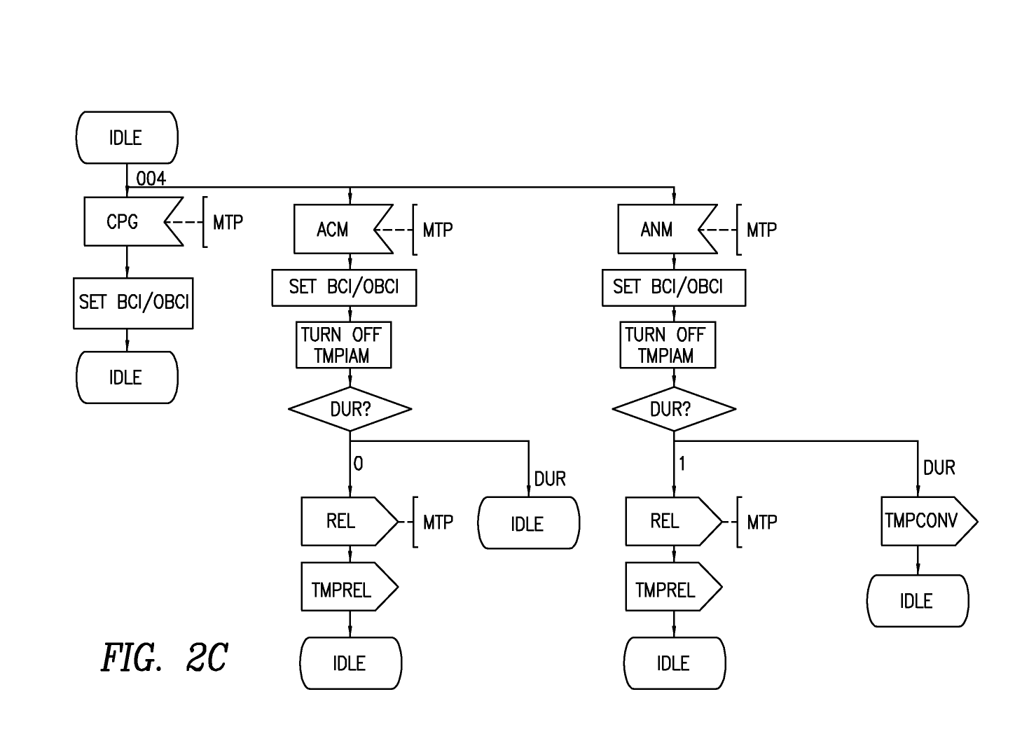

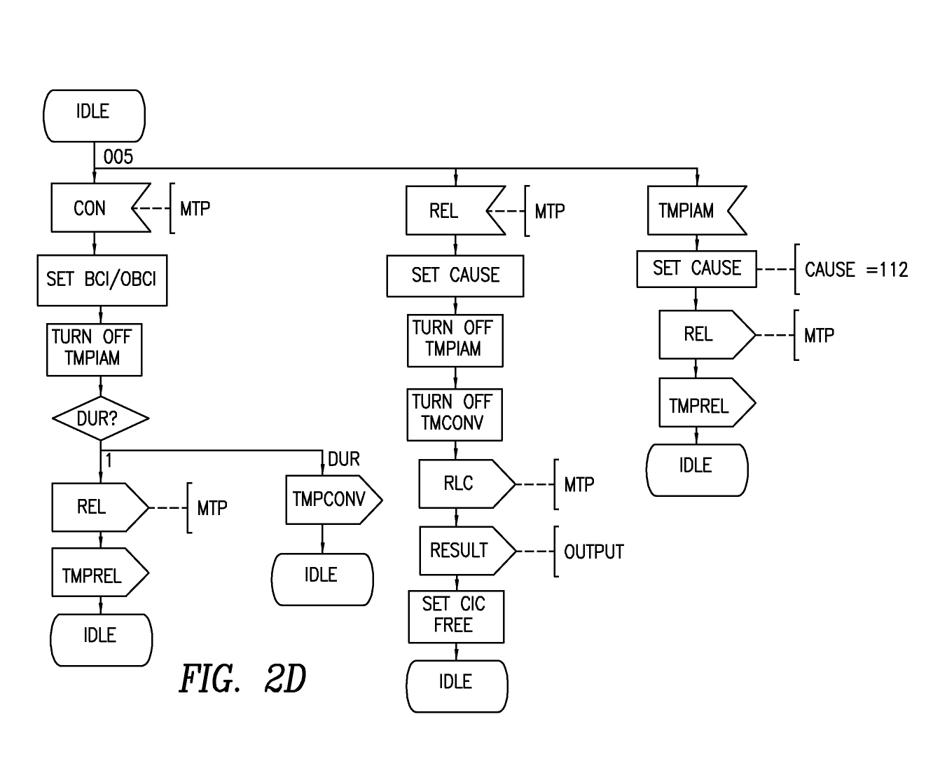

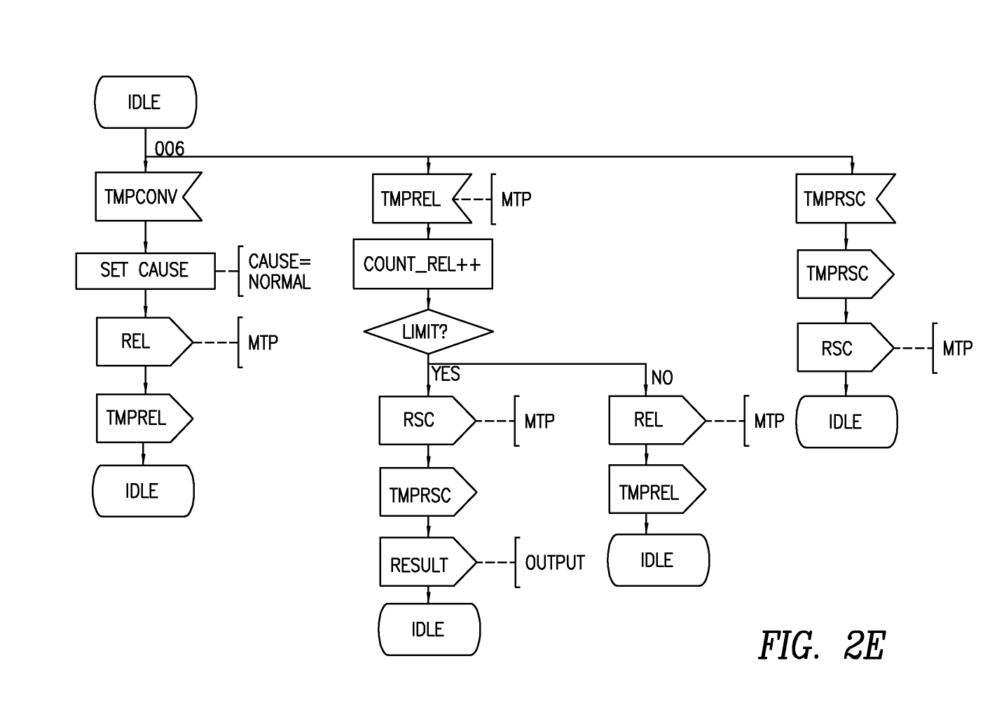

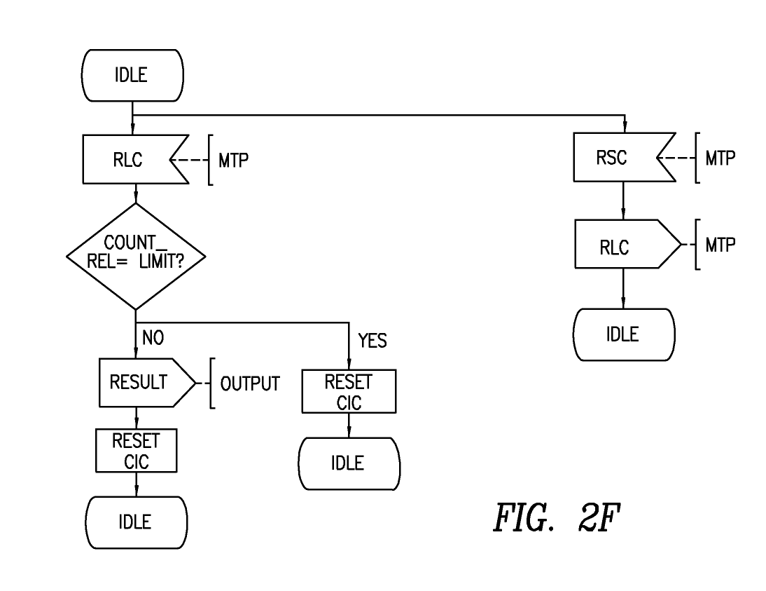

FIG. 2 illustrates a method of collecting and classifying carrier-market information. As is well known in the art, within a SS7 network, the point codes are numeric addresses which uniquely identify each signalling point and the Destination Point Code (DPC) identifies the receiving signalling point. In the present invention, publicly available information about carrier number ranges 130 for each carrier-market and the Destination Point Code (DPC) to address each carrier on the SS7 network is collected at step 200. At step 210, for each carrier-market a random, and statistically significant, sample of numbers is generated. The generation of carrier-market samples 210 involves in one embodiment using this information to generate samples of test numbers that accurately represent the population of numbers in each carrier-market. The generated samples include any relevant information that is associated with the line range that the number is contained in, such as the HLR DPC and any knowledge about whether the number is pre-paid or post-paid. Generated samples are stored in a database. At selected intervals, such as but not limited to at least once each reporting period, each sample of numbers is tested at step 220 for each carrier-market for which reporting is provided. Testing 220 generates data to which rules are applied 228 to classify the number as assigned or unassigned, pre-paid or post-paid and/or dormant or active. Result information may be stored such as in a database, server, warehouse or the like. At step 230 statistics are computed regarding the percentage and distribution of dormant numbers in a carrier market. In step 240 reports are generated using current and historic result information.

Now referring to FIG. 2A in an embodiment step 220 is described in further detail, wherein a software application 224 may run tests to generate signaling information 226 which may be categorized for example as CPG (call progress), ACM (address complete), ANM (answer), CON (connection), REL (release), or T/O (timeout). Now referring in further detail to FIGS. 2A-2F, an exemplary software routine is disclosed for testing telephone numbers/chips to generate signaling information which may be used to classify the number(s) as unassigned, assigned, dormant or the like.

It will be apparent to those skilled in the art that the reporting frequency 250 may be any suitable frequency such as but not limited to hourly, daily, weekly or the like. In addition, samples can be regenerated as needed.

It will be further understood that the generation of representative samples is not limited to any single method. For example, it is believed a representative sample may be achieved by generating an even distribution of random numbers within an allocated number block range. However, other factors may be considered and employed in generating a representative sample.

Methods of generating a sample of test numbers for each carrier-market are known in the art. For example, a database of carrier-market information may be initialized and periodically updated with information about number allocations to markets and with information necessary to address relevant carrier network equipment on the SS7 network. The process of generating samples may be iterated over the set of all carriers of interest. For each carrier the process of generating samples may then iterate over each market. For each carrier-market the population of numbers allocated to the carrier may be determined using information stored in the carrier database. A randomly selected, statistically significant, subset of numbers within the population may then be generated. The numbers that compose the carrier-market sample are stored in a database for later testing. Relevant attributes for the carrier or number block may be stored with each number. For example, the SS7 Destination Point Code (DPC) of the carrier Home Location Registry (HLR) may be associated with each number. In one embodiment, in cases in which the number is pre-paid or post-paid is an attribute of the number range of which the number is a part, this attribute may also be stored.

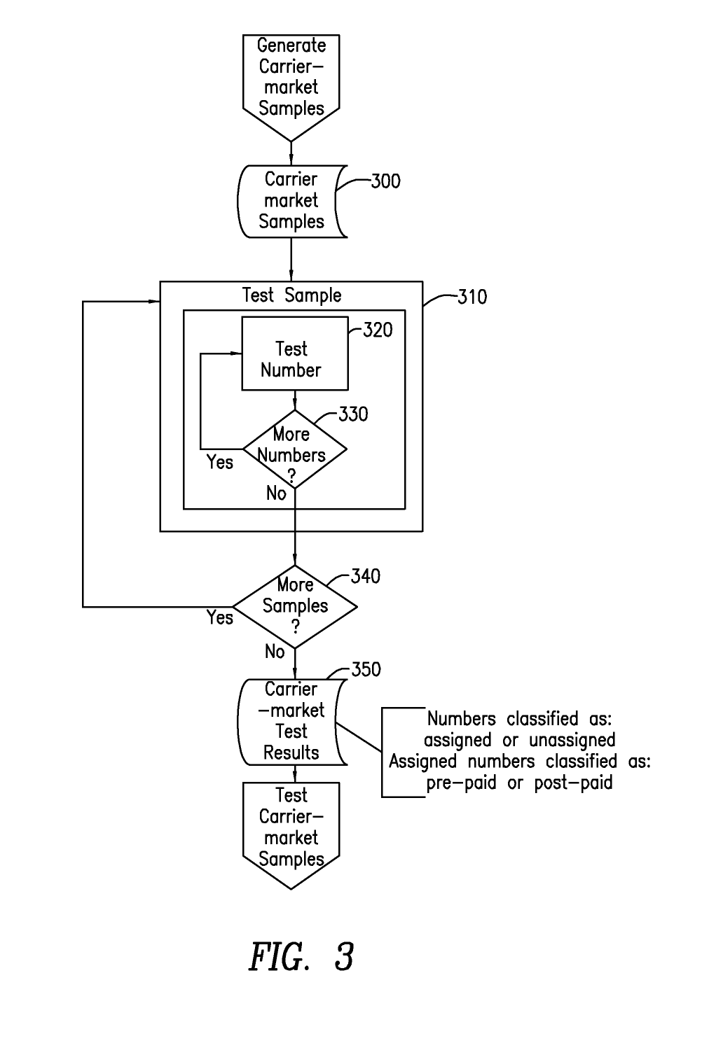

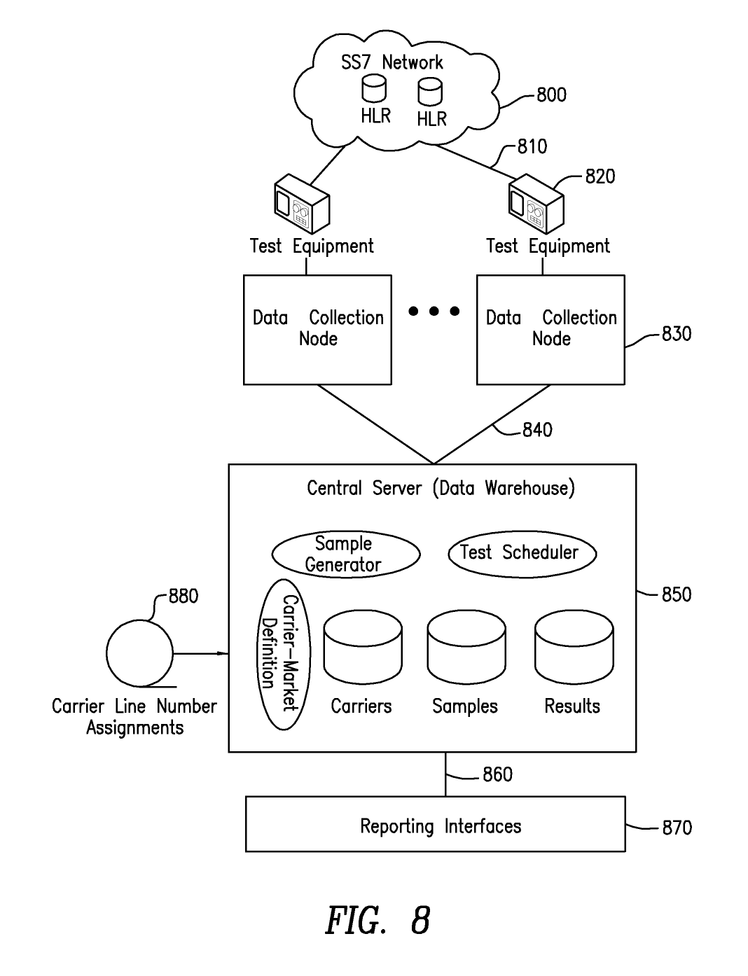

FIG. 3 illustrates a method of testing carrier-market samples. This may be an iterative process that operates on each sample of numbers generated during the “generate carrier-market samples” step described above and stored in the carrier-market sample database (300). Each number in the sample is tested (320) to determine if it is assigned or unassigned. Numbers classified as assigned are further tested and classified as either pre-paid or post-paid. Using the methods and apparatus described herein, numbers determined to be assigned may be subjected to testing to determine whether they are dormant. Results are stored in a results database. In some cases it may occur that the result of testing a number is indeterminate, due perhaps to a transient network condition. In such cases in one embodiment the test result for the number is marked as such and the number may be retested at a future time. It is preferred that the entire testing process be complete within the time required by the desired reporting cycle. As further illustrated in FIG. 8, a system using the method may be implemented such that multiple data collection nodes and multiple pieces of SS7 test equipment are used as necessary to achieve the systems' test throughput requirements.

In one embodiment SS7 signaling, manual dialing or autodialing may be employed to test random numbers selected from any carrier-market desired. It is not necessary that a random sample of numbers be obtained prior to testing for dormancy. In some instances a particular set of numbers may have already been identified as likely to be dormant, and testing may proceed only as to that set of numbers.

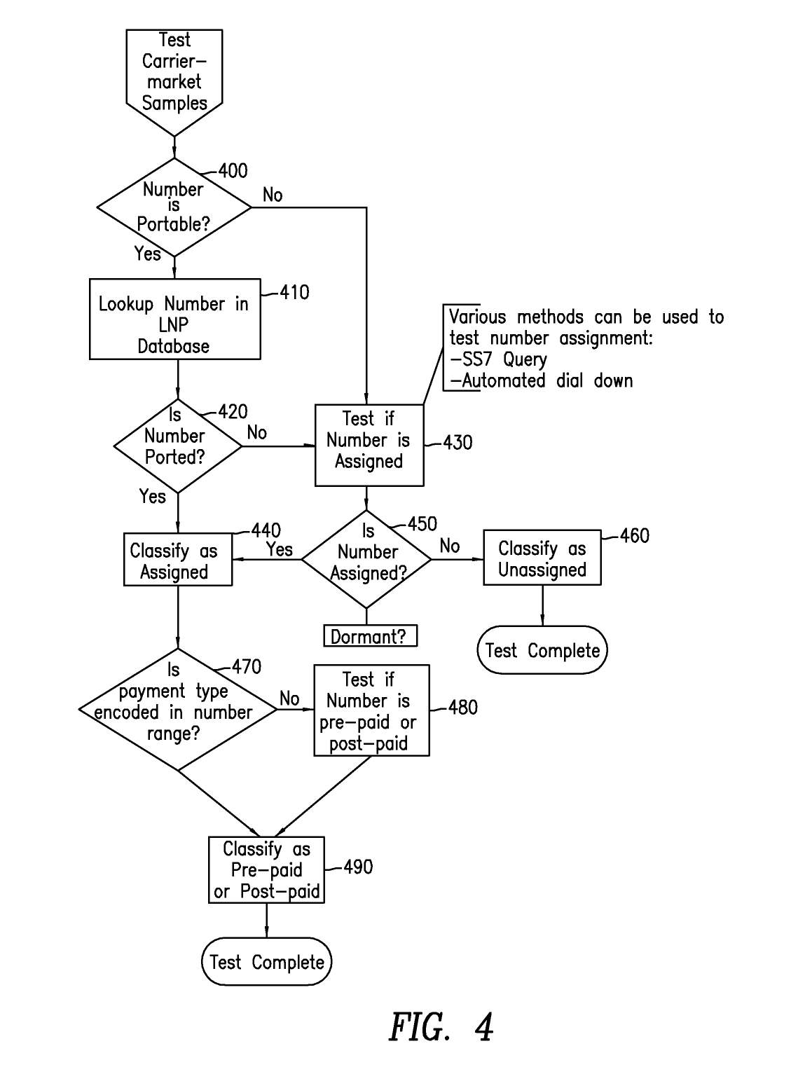

FIG. 4 illustrates a process of testing an individual number for dormancy in the context of a method wherein numbers are tested for assigned/unassigned status from a carrier-market sample. If Local Number Portability (LNP) is supported (400), an SS7 request is issued to query the LNP database for the number. If the number is found (420) it is by definition assigned to a subscriber and is classified as such. Otherwise, if LNP is not supported or the number was not found in the LNP database, one of several possible methods are used to determine if the number is assigned or unassigned. For example, a SS7 query can be implemented or an automated or manual dial down can be performed. If the number is unassigned (450) it is classified as such (460) and testing of the number is complete. Determining whether an assigned number is dormant may then proceed. Optionally further determining whether a number is prepaid or postpaid can occur in several ways depending on the characteristics of the carrier-market. In some cases it may be an attribute of the number range of which the number is a member (470) in which case no further testing is required. In some cases it may be evident from the test results from testing whether the number is assigned or unassigned. If neither of these cases is true, the assigned number is further tested to determine whether the number is pre-paid or post-paid (480). The number is then classified based on the results of the test (490). It will be apparent to those skilled in the art that the determination of whether a number is pre-paid or post-paid, discussed in further detail hereinbelow, can be made prior to the determination as to whether the number is potentially or actually dormant.

It will be apparent to those skilled in the art that a variety of methods may be employed to determine whether or not a number is assigned to a subscriber. These methods range from the manual or automated calling of numbers to the use of SS7 signaling to query the carrier's HLR. Applicable techniques depend on the characteristics of the carrier-market network under test. For example, the methods described in U.S. Pat. No. 6,751,295, incorporated in its entirety herein by reference, may be employed.

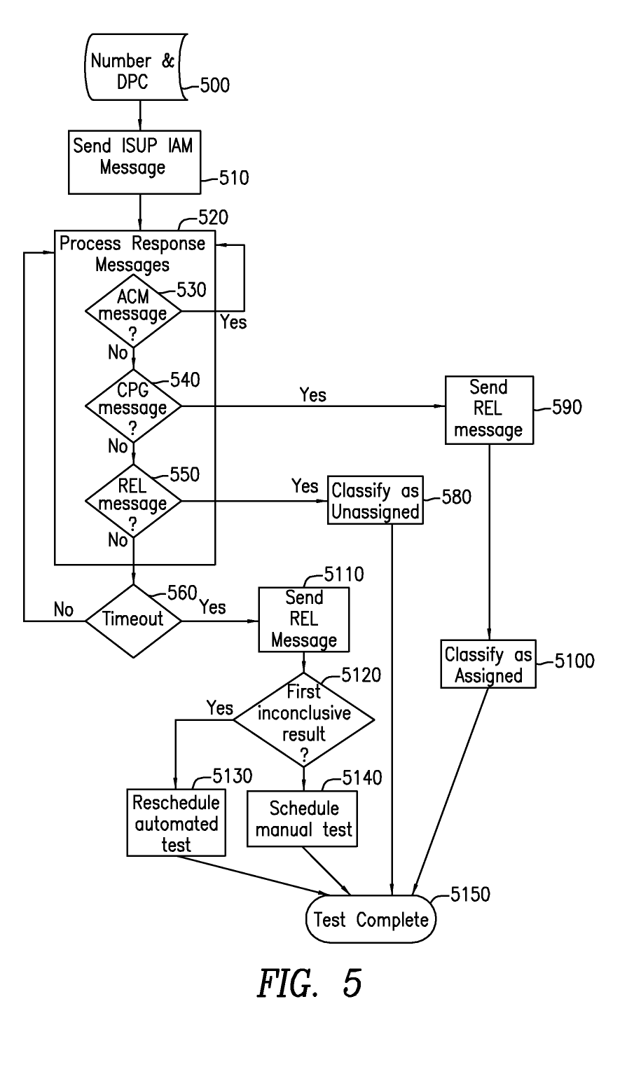

Now referring to FIG. 5, in one embodiment a method is illustrated that uses ISDN User Part Protocol (ISUP) to generate the signaling necessary to initiate, and immediately terminate, a call to the number under test. In one embodiment the method is implemented by a system having architecture such as that depicted in FIG. 8, described in further detail hereinbelow. An ISUP IAM (Initial Address Message) is sent (510) to the destination switch for the number under test. The system then enters a loop waiting for response messages (520). If an ACM (Address Complete Message) is received (530) the system returns to wait for a CPG (Call Progress Message) (540). When a CPG message is received, the system sends a REL message (590) to terminate the call, classifies the number as assigned (5100), and terminates the test (5150). If a REL message is received (550) the system classifies the number as unassigned (580) and terminates the test (5130). If the system does not receive the expected messages within a configured timeout threshold, it sends a REL message (5110) to terminate the call. If this is the first inconclusive result (5120) the number is scheduled for automated retest (5130); otherwise, the number is schedule for classification using a manual testing method (5140).

In one embodiment, a number classified as a dormant or potentially dormant chip has the following characteristics, preferably already established through testing:
1) The number is currently classified as “assigned” by the carrier;
2) The number is classified as “pre-paid” where possible to determine such. Post-paid numbers still generate revenue for carriers, even if abandoned by the subscriber, through the recurring monthly fees, therefore while technically abandoned these numbers are not best described as “dormant”.
3) The number is an assigned, pre-paid number; yet the responses received during testing indicate that the phone is not active. For example, no originating messages in responses to tests are received (SMS, etc.; in Brazil for example, some carriers send an SMS message to callers when a phone that they have previously called (that was then off), is later turned on. “You called John. His phone was off. He just turned it on. You should call him now.”); no responsive signaling is received during testing (answer, personal voicemail, etc.); and this state is maintained for a period of time.

Determining the status of a number can be achieved by various means, such as by analysis of signaling and audio analysis.

Analysis of signaling is a preferred method for determining the status of the number called, preferably by identification of patterns in SS7 ISUP signaling that may indicate that the number is associated with a potentially dormant chip. Most if not all dormant or potentially dormant chips will typically have all the following characteristics:
1) Testing receives responsive signaling that indicates that the SIM card is removed from the handset, the called party is out of area, or that the phone is powered off (and is never turned on).
2) Does not have mailbox: the operator has either disabled the mailbox for lack of use, or the mailbox will be fully loaded;
3) Immediately after the call connection there is an immediate disconnection;
4) The call is not charged.

Audio analysis of calls is an alternative method and includes determining the status of the number called based on the identification of audio messages received before the call is ever answered. For example, when there is no ringing when called, an automatic message typically answers the call indicating that the chip is removed from the handset, or that the phone is powered off (and is never turned on).

In a preferred embodiment a method of identifying whether a chip is dormant includes determining whether the number is assigned or unassigned as described herein; determining whether the number is pre-paid or post-paid according to the methods described above; identifying numbers that are potentially dormant chips; for all numbers marked as potentially dormant chips, setting a new frequency and/or time of tests, so that the marked numbers can be tested more often at different times and different days of the week for a certain period, which period may be termed the “observation period”; and analyzing the classification of the marked numbers during the Observation Period. If during this entire test period the number remains classified as a potentially dormant chip, then this number is categorized as a dormant chip.

In some markets it is common for an SMS message to be automatically sent from a cellular phone, which was called when it was off, or out of a cellular coverage area (to the phone originating the call). This notifies the original caller that the called party (phone) is now on, or back in coverage, and is available to receive calls.

In accordance with this embodiment, originating the test calls (for dormancy) from a cellular interface (either a cell phone or a computer board with cellular capabilities), that is designed to receive these SMS messages, allows for the system to recognize a number that is in use, and as such, would be labeled as active (not dormant). This embodiment may be operable in accordance with the systems and/or methods of the present invention whereby once the determination is made that a number is assigned, pre-paid and likely dormant, the Observation Period testing may be conducted from this system. For example, the operating software may label a number as potentially dormant and create a listing of the numbers in this classification. The cellular interface system then places test calls from that point forward, recording the results. If a number answers, is ever on, or sends a SMS, then it may be designated active and hence not dormant. If the testing of the number proceeds through the observation period without changing from “potentially dormant” for the test period, then it is labeled dormant.

The foregoing system could be interchangeable with an ISUP call generator described in other embodiments herein from the point that a chip is identified as potentially dormant.

The foregoing embodiment may employ an autodialer with a cellular interface (that can both make the calls and receive SMS messages), that is trained to recognize the SMS originating number when and if it receives one, and then classifies the number correctly. In one embodiment, a VoIP GSM gateway may be employed to enable direct routing between IP, digital, analog and GSM networks. In one embodiment a GSM board can be placed directly in a VoIP PBX, such as but not limited to an Asterisk PBX (free PBX) to generate the calls. Fixed cellular terminals enable companies to significantly reduce the money they spend on telephony, especially the money spent on calls from IP to GSM. Through least cost routing the gateways select the most cost-effective telephone connection. The gateways check the number which is dialed as well as rate information which is stored in an internal routing table. Because several SIM cards and GSM modules are integrated within the VOIP GSM gateway it is able to make relatively cheaper GSM to GSM calls instead of expensive IP to GSM calls.

Once the number is classified as a dormant chip, a statistical model can be used to measure the quantity of numbers of dormant chip within each carrier's subscriber-base.

Several methods can be used for determining whether an assigned, dormant number is pre-paid or post-paid. In one embodiment a method includes using knowledge about number range assignments to make such identification. In another embodiment, a method is employed which decodes information from SS7 signaling that identifies whether the assigned number is pre-paid or post-paid. In another embodiment, a method employs extracting CDRs (Call Data Records) from the carrier's billing system.

In accordance with one embodiment, a method is provided using knowledge about number range assignments to make an identification of whether an assigned, dormant number is pre-paid or post-paid. As mentioned above, in some cases, whether an assigned, dormant number is pre-paid or post-paid is an attribute of the number range of which the number is a member. In such event the method includes identifying the attribute and analyzing a selected assigned, dormant number to determine whether it contains the attribute.

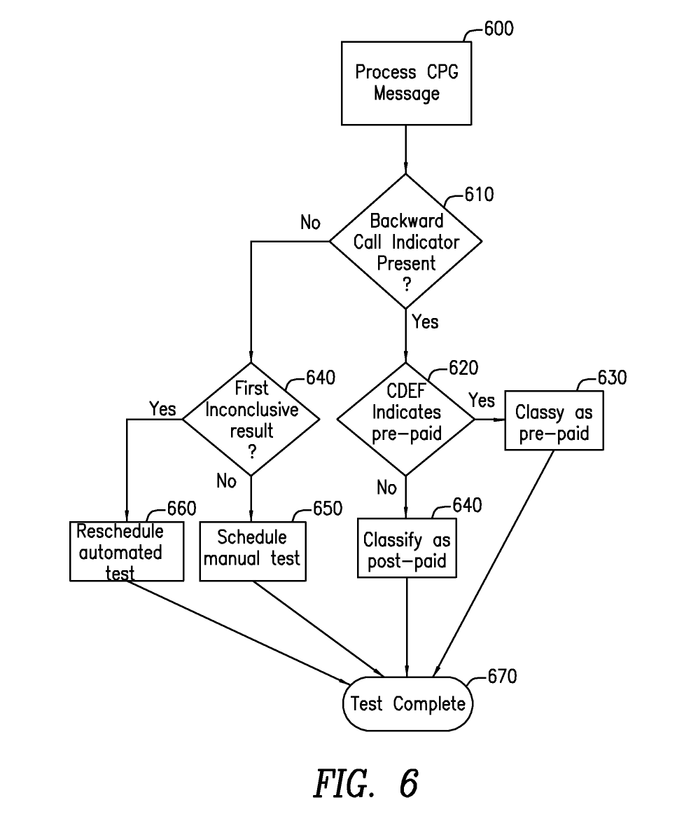

Now referring to FIG. 6 a method is illustrated which employs the use of SS7 signaling to classify whether an assigned, dormant number is pre-paid or post-paid. In one embodiment this is an additional processing step to the method illustrated in FIG. 5 for determining whether a number is assigned or unassigned. In this example the Call Progress Message (CPG) is analyzed, however it will be clear to those skilled in the art that other messages such as the ANM or ACM could be analyzed in the same way. CPG message (600) is examined to determine whether it contains a Backward Call Indicator parameter (610). If present, the CDEF parameter is examined (620) to determine if the number is pre-paid. If so, it is classified as such (630) and testing is terminated (650). If the CDEF parameter indicates the number is post-paid, it is classified as such (640) and testing is terminated. In the event that the CPG message does not contain the required response parameters (610) the result is inconclusive (640). If it is the first inconclusive result the number is scheduled for automated retest (650) at a future time; otherwise, the number is scheduled for classification using a manual testing method (660).

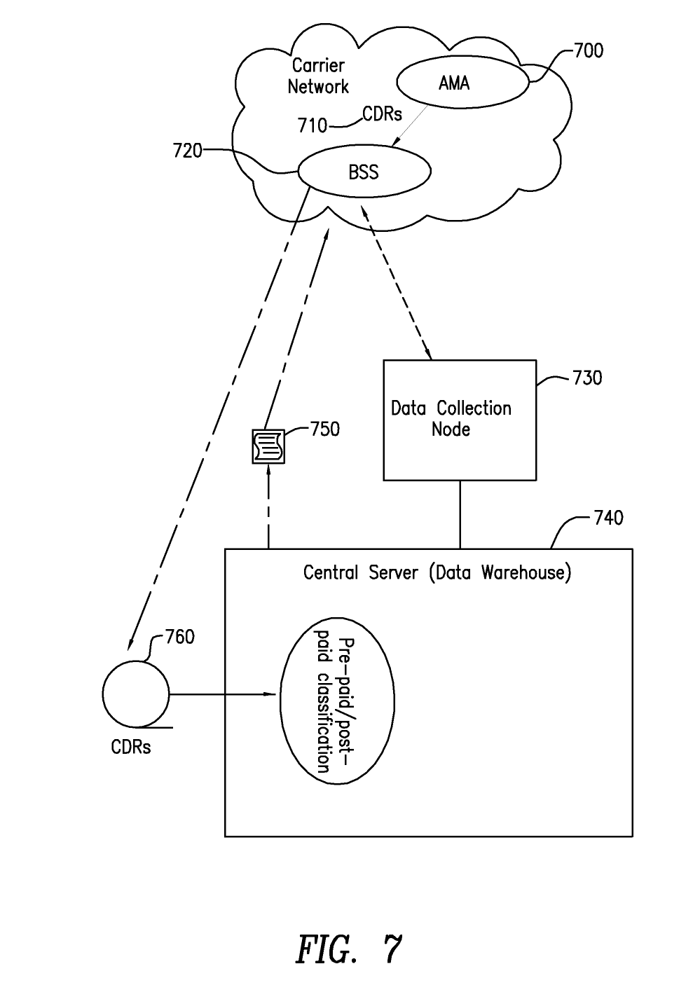

It is observed that for some carrier-markets, the information regarding whether or not a number is pre-paid or post-paid is stored in the billing system and may or may not be encoded in network signaling. It may be desirable to employ a method of extracting such information from the billing system. Now referring to FIG. 7, illustrated is a method of extracting CDRs (Call Data Records) from a carrier's billing system. In one embodiment, when a call is processed, Automatic Message Accounting (AMA) software 700 records/updates CDRs 710 for the number, which includes an indication of whether the number is pre-paid or post-paid. This information is stored in the Billing Support System (BSS) 720. To obtain this information a relationship is established between the measurement system and the carrier. In one embodiment, a data collection node 720 uses network access to obtain the information for the numbers under test. In another embodiment, for a given set of numbers under test 750 the relevant information is exported 760.

Now referring to FIG. 8, illustrated is an embodiment of a logical architecture of a system capable of making the required measurements in order to generate reports in accordance with the present invention. Such a system consists of data collection components 820, 830, a central server 850, and reporting mechanisms 870. The data collection components include an SS7 interface 820, or internal card or external test equipment, that interfaces (810) to the SS7 network 800. As will be apparent to the skilled artisan, there are a variety of possible ways that the test equipment can be connected such as but not limited to a direct A link connection to a Signal Transfer Point (STP) or using a monitoring link to existing A links. Data collection nodes 830 serve as controllers of the test equipment coordinating the testing of a sample of numbers. It is contemplated that there may be a one-to-one correspondence between data collection nodes 830 and test equipment or a single node could control multiple pieces of test equipment. Additional data collection nodes 830 and test equipment can be added as necessary to meet the throughput/scalability requirements of the system. Data collection nodes 830 are connected via a network connection 840 to a central server 850 which uses publicly available data about wireless service provider line number range assignments 880 to generate, maintain, and store carrier-market samples. The central server 850 preferably schedules and load-balances the execution of carrier-market sample tests across data collection nodes 830. The central server 850 stores test results for the period necessary to generate required reports. The central server 850 fulfills the role of test controller and data warehouse. In accordance with one embodiment the system may provide any variety of reporting interfaces 870, such as but not limited to using existing Online Analytical Processing (OLAP) mechanisms to providing customers with direct data feeds.

In accordance with one embodiment a method of determining whether a chip is dormant includes the steps of defining a sample of numbers to be tested; with the monitoring of the activated signaling, initiating a telephone call to a number/chip to be tested, sorting the results/assigning status of chips tested, i.e., dormant vs. active, and optionally indeterminate.

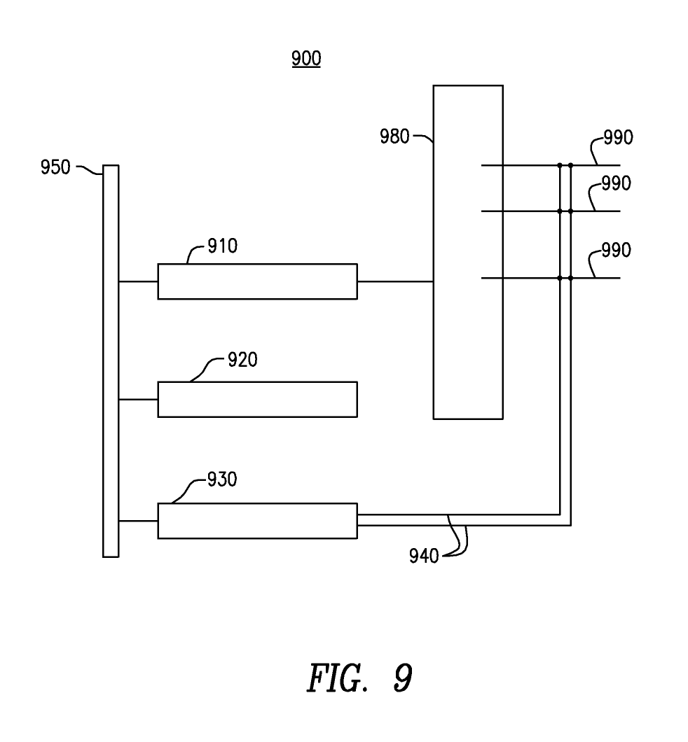

Now referring to FIG. 9, a system 900 operable to test a chip for dormancy includes a call generator 910, server 920 and signaling monitor 930 interconnected via a network 950, preferably an IP network. Call generator 910 is connected to a telephone exchange and generates a call to a number associated with a chip. Call generator 910 may be an autodialer or any suitable device for initiating calls as will be apparent to those skilled in the art. Call generator 910 may be programmed to initiate calls to numbers based on any criteria, such as but not limited to randomly, according to a list, according to programming installed on the generator 910 or server 920, in response to input from monitor 930, in conjunction in accordance with the methods and techniques set forth above or the like. Call generator 910 may be a conventional device or an automatic system with means for recording, so that it is possible to clearly identify the status of the terminal for which the call is directed. In some cases a chip that may otherwise be dormant may have an active voice mail, which could make difficult the method of identification through mere signaling. In this event, system 900 includes a recording device for recording the result of calls made during testing and optionally an automatic system of voice recognition to identify if the answer was automatic (voice mail) or not (subscriber). In the event the answer is automatic during a given testing period, and not at any point a subscriber response, the chip can be determined to be dormant.

Server 920 may be programmed with instructions for the call generator 910 and/or the signaling monitor 930 in accordance with the techniques and methods described herein. Server is operable to process information in accordance with the techniques and methods described herein.

Signaling monitor 930 is connected via signaling probes 940 to one or more telecom operators 990 via a suitable transmission connection such as a T1, E1 or other line using a suitable transmission format for collecting data. Data is collected and sent to server 920 for processing. It will be apparent to those skilled in the art that the call generator 910, server 920 and or signaling monitor 930 may be contained in a single unit.

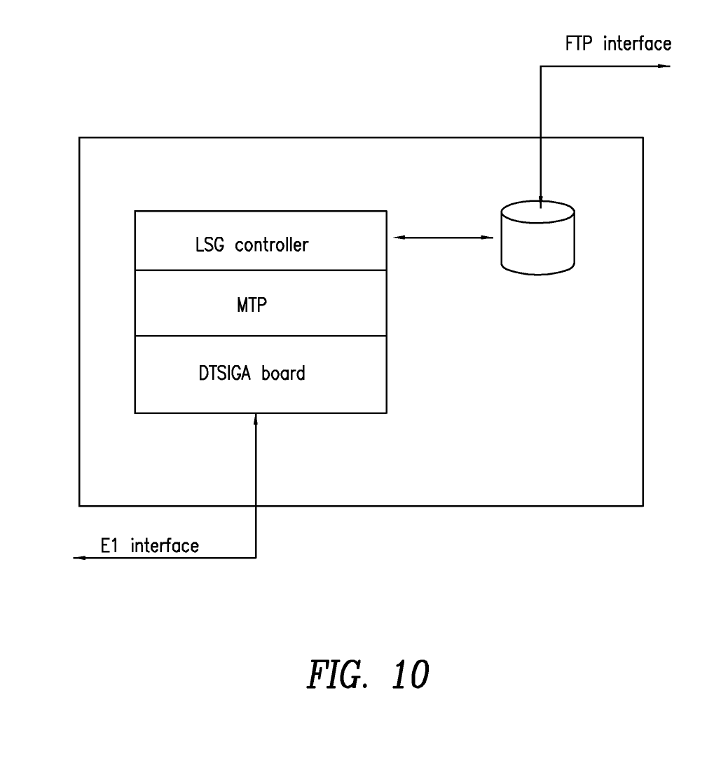

By way of example, in one embodiment a suitable system includes the LCG3000 available from Labcom Systems of Campinas, which is operable as an endpoint of a SS7 ISUP signaling link over one 64 Kbps channel in an E1 link. The desired software application runs in a server 920 and commands the call generation in call generator 910. For purposes of this example the LCG3000 is a combined call generator 910 and signaling monitor 930. The LCG3000 and the server 920 are both connected to the same IP network. The interface LCG/Server works on batch file mode. The server transmits (FTP) a batch file to the LCG3000 and at the end of processing the LCG3000 writes a result file to be downloaded by the server. Exemplary software blocks inside the LCG3000 are shown in FIG. 10. The DTSIGA board drives one ISUP signaling channel in the E1 interface. The software MTP treats the physical level (MTPJ), the link level (MTP2) and the network level (MTP3) of the SS7 stack below the ISUP application part. The software MTP attends the ITU-T rec. Q.703, Q.704, Q.705, Q.706 and Q.707, with the modifications allowed by the rec. Q.710. The LCG3000 controller reads the input file in the ftp:/input directory, does the job and writes back a result file in the ftp:/output directory.

In one embodiment the LCG3000 at a designated start time dials each number in sequence up to the number of available free channels, then, after a given time period, repeats the procedure beginning with the next number and so on during the duration of the test. The test ends after the last number. The test may be suspended after a given time interval and resumes at a given next start time. An output file reports information to the server.

Once information has been collected regarding dormant chips in accordance with the aforementioned techniques, statistics are generated using the information, such as but not limited to percentage of dormant chips, subscriber churn, and gross additions. Statistics may be generated on server 920 or a separate computing device. It will be recognized that some or all of these statistics may be calculated, and may be calculated in any order.

A suitable statistical model that can be employed to generate market dynamics report data may include steps of generating a list containing all the samples (mobile phone numbers), and processing the list on a server generating SS7 signaling messages. The messages are processed in a program, such as one developed with Java, that contains rules that are operable to classify the status of each phone number in one of the following states: Active, Inactive or Unknown. Once the numbers are classified, the subscribers total, the churn and the additions can be calculated.

One suitable algorithm that can be employed to estimate subscribers is the following:

Subscribersₙ=Pₐ×N

where: Pₐ=(active linesₙ)/(active linesₙ+inactive linesₙ+unknown linesₙ). N is the total of lines that the carrier has, including active and free lines.

Subscriber churn is generally recognized as a measurement of how many subscribers terminate wireless service with a particular wireless service provider during a specific time interval. This time interval is typically a month or a quarter. In one embodiment, data collected for example for a list of specific test MINs on January 1 is compared to data collected for the same list of test MINs measured on February 1. For each test MIN it is known whether or not the MIN was assigned or unassigned on January 1, and assigned or unassigned on February 1. Thus, subscriber churn is calculated using the number of test MINs which were assigned on January 1, but were determined to be unassigned on February 1. The result of this comparison is divided by the sample rate to estimate the total churn for each wireless service provider.

In addition, other churn statistics can be calculated, as discussed in U.S. Pat. No. 6,751,295, with specific reference to FIGS. 21A-21C and the text directed thereto, incorporated herein by reference.

In accordance with one embodiment, to calculate churn, it is preferred to have historical data of two months. The total of active numbers at the first month (Tₙ₋₁) is verified, and then the numbers in this list that turned inactive the following month (Tₙ) is verified. The following algorithm can be applied to calculate the percentage of churn: Churn percentageₙ=(Tₙ/Tₙ₋₁)*100 where: Tₙ₋₁ is the total of active numbers in the month N−1. Tₙ is the total of numbers that turned inactive in the month N. This percentage in the subscribers total of the month N−1 is applied to get the estimated count of lost subscribers in the month N, that can be expressed with the following algorithm: Churn countₙ=(Churn percentageₙ/100)*Subscribersₙ₋₁ Where: Churn percentageₙ is the percentage calculated previously. Subscribersₙ₋₁ is the total of subscribers in the month N−1 (previous month).

Subscriber gross adds is a measurement of how many subscribers begin wireless service during a specific time interval, the time interval typically being a month or a quarter. To determine gross adds, a comparison of data from one test period (such as for example January 1) to another (February 1) is made. It should be recognized that a wireless service provider could have added new line ranges to accommodate expansion after the January 1 measurements but before the February 1 measurements. Thus, a modified set of test MINs will include the test MINs used for the January 1 measurements plus a given sampling rate (for example, 5%) times the number of MINs in the new line range. For example, if wireless service provider A adds a range of 10,000 new MINs in January, the February modified test MINs would include an additional 500 MINs, i.e., 10,000 new MINs times the 5% sampling rate. Thus, the present invention can determine the number of test MINs which were unassigned on January 1 but were assigned on February 1.

To calculate the estimated gross add MINs, the number of MINs unassigned on January 1 which were assigned on February 1 is divided by the sampling rate. As an example, wireless service provider A and wireless service provider B had 73 and 57 test MINs, respectively, unassigned on January 1 and assigned on February 1. Using the 5% sampling rage, the estimated gross adds of MINs for wireless service provider A is 1460 (i.e., 73.div.0.05), and the estimated gross adds of MINs for wireless service provider B is 1140 (i.e., 57.div.0.05). In addition, other gross add formulas may be employed. For example, the gross add formula can be modified such that the denominator represents the average of the subscribers at the beginning of the measurement period and the end of the measurement period. A wireless service provider's subscriber gross add share can also be calculated. For example, wireless service provider A has a subscriber churn share is 56.15%, i.e., 1460.div.(1460+1140). To calculate the gross add percentage for each wireless service provider over the one month period, the estimated gross add MINs is divided by the number of estimated MINs for that wireless service provider at the beginning of the period. Accordingly, the gross add percentage for wireless service provider A is 10.90% (i.e., 1460.div.13,400), and the gross add percentage for wireless service provider B is 6.70% (i.e., 1140.div.17,000).

In one embodiment, additions may be calculate using the following algorithm:

Adds countₙ=Subscribersₙ−(Subscribersₙ₋₁−Churn countₙ)

Where: Subscribersₙ is the total of subscribers in the month N. Subscribersₙ₋₁ is the total of subscribers in the month N−1. Churn countₙ is the Churn count in the month N.

To obtain the percentage of the additions the following algorithm can be applied:

Adds percentageₙ=(Adds countₙ/Subscribersₙ₋₁)*100

Where: Adds countₙ is the Adds count of the month N. Subscribersₙ₋₁ is the total of subscribers in the month N−1.

Since the Location Routing Number obtained using the Local Number Portability DIP identifies to which particular service provider a particular MDN/telephone number is assigned, more detailed market statistics can be generated with this information. Specifically, a measurement of dormant chips can be calculated. For example, it can be assumed for purposes of illustration that on January 1, 10,000 telephone numbers are sampled, and that each sample is served by its native service provider, i.e., the Location Routing Number field of the SS7 DIP response message indicates no Location Routing Number. Performing the Local Number Portability database DIP on February 1 for the same market can increase or decrease of dormant chips for each service provider. This information is useful to both landline and wireless service providers. The Local Number Portability database DIPs are so fast and inexpensive that it is feasible to perform the DIPs for all telephone numbers and all MDNs in a market. Accordingly, errors will be eliminated because the entire population of the market can be sampled.

Since all MDNs in a market can be quickly and inexpensively tested using the Local Number Portability database, a subscriber churn history statistic can be calculated. Specifically, by testing the MDNs over a period of time, the number of times a particular MDN has been dormant over the period of time can be tracked. This information can be very useful to service providers as it shows which subscribers are more likely to use the service provider. Of course, a subscriber which leaves a chip dormant is less attractive to a service provider than one who uses the chip and generates income for the subscriber.

The calculation of market data can be performed at the conclusion of testing or while the testing is proceeding, preferably on a rolling basis. In one embodiment, the calculation includes determining the total number of chips for a given provider and the total number of dormant chips for that provider. This assessment can be made for each provider of interest. This calculation can be made for each provider in a given market to determine the total ratio of dormant chips.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

The following tables contain definitions of acronyms used herein.

ISUP Message Table

| Acronym | Message |
|---|---|
| ACM | Address Complete |
| ANM | Answer |
| BLO | Blocking |
| BLA | Blocking Acknowledgment |
| CMC | Call Modification Completed |
| CMRJ | Call Modification Reject |
| CMR | Call Modification Request |
| CPG | Call Progress |
| CGB | Circuit Group Blocking |
| CGBA | Circuit Group Blocking Acknowledgment |
| CQM | Circuit (Group) Query |
| CQR | Circuit (Group) Query Response |
| GRS | Circuit Group Reset |
| GRA | Circuit Group Reset Acknowledgment |
| CGU | Circuit Group Unblocking |
| CGUA | Circuit Group Unblocking Acknowledgment |
| CRM | Circuit Reservation |
| CRA | Circuit Reservation Acknowledgment |
| CVR | Circuit Validation Response |
| CVT | Circuit Validation Test |
| CSVR | CUG Selection and Validation Request |
| CSVS | CUG Selection and Validation Response |
| CRG | Charge Information |
| CFN | Confusion |
| CON | Connect |
| COT | Continuity |
| CCR | Continuity Check Request |
| DRS | Delayed Release |
| EXM | Exit |
| FAC | Facility |
| FAA | Facility Accepted |
| FAD | Facility Deactivated |
| FAI | Facility Information |
| FRJ | Facility Reject |
| FAR | Facility Request |
| FOT | Forward Transfer |
| IDR | Identification Request |
| IRS | Identification Response |
| INF | Information |
| INR | Information Request |
| IAM | Initial Address |
| LPA | Loop Back Acknowledgment |
| NRM | Network Resource Management |
| OLM | Overload |
| PAM | Pass-along |
| REL | Release |
| RLC | Release Complete |
| RSC | Reset Circuit |
| RES | Resume |
| SGM | Segmentation |
| SAM | Subsequent Address |
| SUS | Suspend |
| UBL | Unblocking |
| UBA | Unblocking Acknowledgment |
| UCIC | Unequipped CIC |
| UPA | User Part Available |
| UPT | User Part Test |
| USR | User-to-user Information |

ISUP Parameter Table

| Acronym | |
|---|---|
| | Access Delivery Information |
| | Access Transport |
| | Automatic Congestion Level |
| BCI | Backward Call Indicators |
| Cause | Cause Indicators |
| OBCI | Optional Backward Call Indicators |

Glossary of SS7 Acronyms

| Acronym | |
|---|---|
| ASE | Application Service Element |
| BIB | Backward Indicator Bit |
| BSN | Backward Sequence Number |
| CCITT | International Telegraph & Telephone |
| | Consultative Committee |
| CCS | Common Channel Signalling |
| CIC | Circuit Identification Code |
| DPC | Destination Point Code |
| DUP | Data User Part |
| FCS | Frame Check Sequence |
| FIB | Forward Indicator Bit |
| FSN | Forward Sequence Number |
| FISU | Fill-in Signal Unit |
| GTT | Global Title Translation |
| ISP | Intermediate Service Part |
| ISPC | International Signalling Point Code |
| ISUP | ISDN User Part |
| LI | Length Indicator |
| LSSU | Link Status Signal Unit |
| MSU | Message Signal Unit |
| MTP | Message Transfer Part |
| NSP | Network Services Part |
| OMAP | Operations and Maintenance Application Part |
| OPC | Origination Point Code |
| OSI | Open Systems Interconnection |
| SANC | Signalling Area Network Code |
| SCCP | Signalling Connection Control Part |
| SEP | Signalling End Point |
| SF | Status Field |
| SI | Service Indicator |
| SIF | Signalling Information |
| SIO | Service Information Octet |
| SLC | Signal Link Code |
| SLS | Signal Link Selection |
| SNM | Signalling Network Management |
| SNT | Signalling Network Testing |
| SP | Signalling Point |
| SPC | Signalling Point Code |
| SPR | Signalling Point W/SCCP Relay function |
| SSF | Sub-Service Field |
| STP | Signal Transfer Point |
| SU | Signal Units |
| TC | Transaction Capabilities |
| TCAP | Transaction Capabilities Application Part |
| TUP | Telephone User Part |

What is claimed is:

1. A method for determining whether a cellular telephone chip is dormant comprising:
sending a signal to at least one telephone number associated with the chip;
interpreting a response to the signal to determine whether the chip is dormant.

2. The method according to claim 1 wherein the signal is a SS7 signal.

3. The method according to claim 1 wherein the step of sending a signal comprises initiating a call to the at least one telephone number to obtain at least one response, wherein the at least one telephone number is assigned by a wireless service provider to the chip; and further comprising generating market statistics based on the at least one response.

4. The method according to claim 1 further comprising determining whether a phone number is assigned and optionally determining whether assigned numbers are pre-paid or post-paid.

5. The method of claim 4, wherein the step of determining whether a phone number is assigned comprises sending a message to a database associated with at least one of the plurality of telephone numbers and wherein the determination of whether a number is assigned employs the response to said message.

6. The method of claim 5, wherein the database is a wireless service provider home location registry.

7. The method of claim 6, comprising sending the message over the SS7 network to query the home location registry.

8. The method of claim 5, comprising sending the message to a local number portability database.

9. The method of claim 1, wherein the interpretation of the response employs ISDN call set-up signaling.

10. The method of claim 4, comprising determining whether assigned numbers are pre-paid or post-paid using information contained in a Call Progress Indicator message.

11. The method of claim 3, wherein the market statistics include at least one of percentage of dormant chips, market share, gross additions, subscriber churn, and pre-paid vs. post-paid market share.

12. The method of claim 1 wherein the interpretation of the response employs an automated SS7 signal interpretation algorithm.

13. A method for determining market statistics delineating the percentage of dormant cellular telephone chips for one or more wireless communications service providers comprising determining the total number of chips of a service provider, determining the active or dormant status of at least some of the total number of the chips, and calculating the percentage of dormant chips relative to the total number of chips of the subscriber.

14. A method of identifying whether a chip associated with a telephone number is dormant comprising
determining whether the number is assigned or unassigned;
determining whether the number is pre-paid or post-paid;
testing to identify potentially dormant chips; and
testing potentially dormant chips to identify dormant chips.

15. The method of claim 14 wherein the testing of potentially dormant chips comprises setting a frequency and/or time of tests that is/are different than a frequency and/or time used to identify potentially dormant chips.

16. The method of claim 16 wherein the frequency and/or time is increased.

17. The method of claim 14 comprising determining the quantity of numbers of dormant chips within at least one carrier's subscriber base.

18. the method of claim 14 wherein at least one of the testing steps comprise signal analysis and/or audio analysis.

19. A system operable to determine whether a mobile telephone chip is dormant, the system comprising a call generator, a signaling monitor and server wherein the call generator is connected to a telephone exchange.

20. The system according to claim 14 wherein the server serves as a test controller and data storage warehouse.
